(19) United States
(12) Patent Application Publication
(10) Pub. No.: US 2024/0351375 A1
(43) Pub. Date: Oct. 24, 2024

(54) AXLE ASSEMBLY AUXILIARY FLANGES

(71) Applicant: RV-De-Fender, LLC, Sandy, UT (US)

(72) Inventors: Gregory Adam Bowen, Sandy, UT (US); Todd Ryan Smith, Sandy, UT (US); Zackary Donald Patterson, Harrisville, UT (US)

(21) Appl. No.: 18/304,967

(22) Filed: Apr. 21, 2023

(51) Int. Cl. B60B 35/00; B60B 35/04; B62D 25/16

(52) U.S. Cl. CPC B60B 35/007; B60B 35/04; B62D 25/163; B60B 27/0057

(57) ABSTRACT

An axle can include auxiliary flanges separate from the axle flanges. The auxiliary flanges can be configured to accommodate vehicle protection systems. By incorporating auxiliary flanges, such axles facilitate the installation and use of vehicle protection systems.

### CROSS-REFERENCE TO RELATED APPLICATIONS

N/A

### BACKGROUND

Axles for trailers or other vehicles include “axle flanges” by which the brake assemblies are attached. For example, on a typical recreation vehicle, a drum brake assembly may include a backing plate by which the drum brake assembly is mounted to the axle flange.

U.S. Pat. No. 11,453,444, which is incorporated herein by reference, describes various vehicle protection systems that can be secured to an axle flange to position a protective covering, such as a fender, around a wheel of the vehicle. Due to the variations in axle flanges and other components of the axle, it can be difficult to accommodate such vehicle protection systems.

### BRIEF SUMMARY

The present invention extends to axles that that include auxiliary flanges, separate from the axle flanges, that are configured to accommodate vehicle protection systems. By incorporating auxiliary flanges, such axles facilitate the installation and use of vehicle protection systems.

In some embodiments, the present invention may be implemented as an axle for a vehicle that includes opposing axle flanges that are positioned towards ends of the axle and opposing auxiliary flanges that are spaced inwardly from the axle flanges.

In some embodiments, each of the auxiliary flanges may include one or more holes by which a vehicle protection system is secured to the auxiliary flange.

In some embodiments, the axle may include opposing spring leaf mounts that are spaced inwardly from the auxiliary flanges.

In some embodiments, the auxiliary flanges may be welded to the axle.

In some embodiments, the present invention may be implemented as an axle assembly that includes an axle having opposing axle flanges that are positioned towards ends of the axle and opposing auxiliary flanges that are spaced inwardly from the axle flanges.

In some embodiments, the axle assembly may include a vehicle protection system secured to each auxiliary flange.

In some embodiments, the vehicle protection system may include one or more mounting members that are secured to the auxiliary flange and a fender that is supported by the one or more mounting members overtop a tire that is secured to the axle.

In some embodiments, the axle assembly may include a brake drum assembly secured to each axle flange.

In some embodiments, the present invention may be implemented as an axle for a vehicle that includes opposing axle flanges that are positioned towards ends of the axle, the axle flanges being configured to secure brake drum assemblies to the axle, and opposing auxiliary flanges that are spaced inwardly from the axle flanges, the auxiliary flanges being configured to secure vehicle protection systems to the axle.

In some embodiments, each of the auxiliary flanges may include a plurality of holes by which mounting members of the vehicle protection system are secured to the auxiliary flange.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is an example of an axle that includes auxiliary flanges in accordance with embodiments of the present invention;

FIG. 2 is another example of an axle that includes auxiliary flanges in accordance with embodiments of the present invention; and

FIG. 3 shows how an auxiliary flange of an axle can be used to mount a vehicle protection system to the axle in accordance with embodiments of the present invention.

### DETAILED DESCRIPTION

Embodiments of the present invention extend to axles that include axle flanges and auxiliary flanges. In the context of this specification and the claims, the term “axle flange” should be construed as a flange of the axle to which a brake assembly attaches.

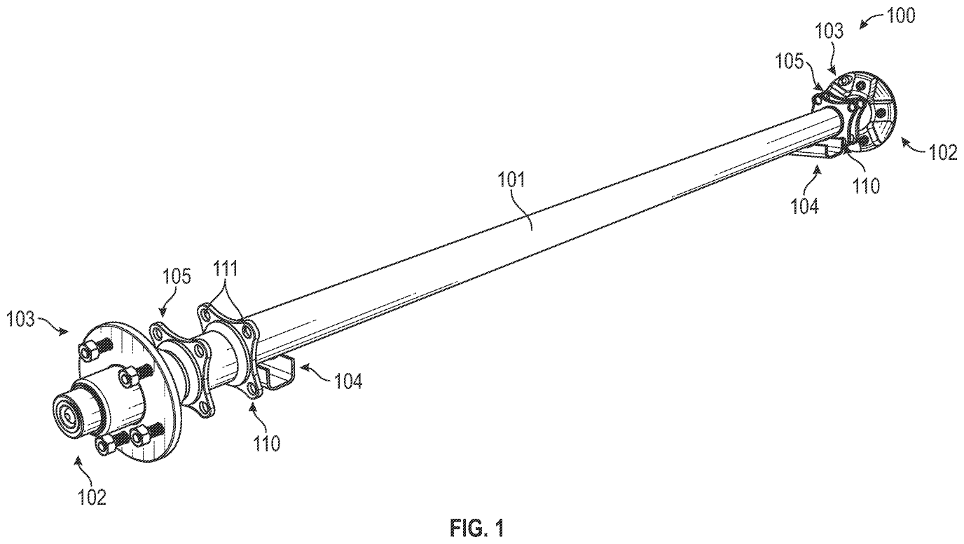

FIG. 1 provides an example of an axle assembly 100 that includes an axle 101 that is configured in accordance with one or more embodiments of the present invention. Axle 101 includes axle flanges 105 and auxiliary flanges 110 that are spaced inwardly from axle flanges 105. Although axle flanges 105 and auxiliary flanges 110 are shown as having the same size and shape, this need not be the case. Auxiliary flanges 110 could be shaped and sized in different ways including having holes 111 in different patterns. Axle 101 also includes leaf spring mounts 104 that may be positioned inward of auxiliary flanges 110 and may be configured to support leaf springs.

In FIG. 1, axle assembly 100 also includes spindles 102 that may be secured (e.g., welded) to the ends of axle 101 and hubs 103 that are secured to spindles 102. Hubs 103 can function to allow wheels to be secured to axle 101.

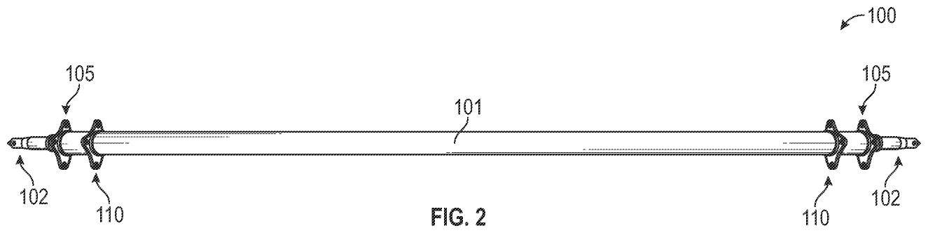

FIG. 2 provides another example of axle assembly 100 where axle 101 does not include leaf spring mounts 104 and hubs 103 have not been secured to axle 101. FIG. 2 is therefore intended to represent that an axle configured in accordance with embodiments of the present invention could include different components which may be selected for a particular application.

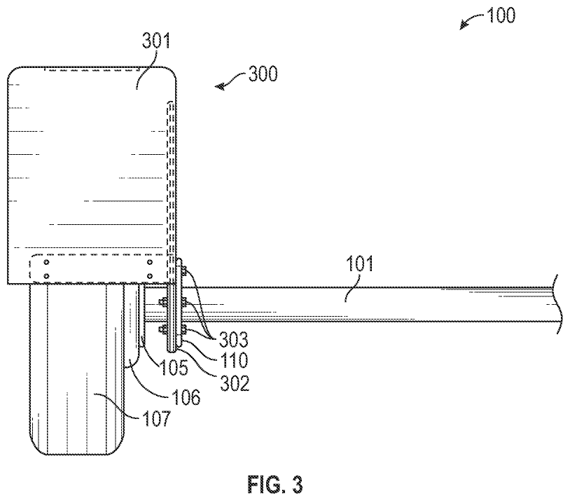

FIG. 3 provides an example of how auxiliary flanges 110 facilitate securing a vehicle protection system 300 to axle 101 to thereby protect a vehicle (not shown) from tire blowouts. In some embodiments, vehicle protection system 300 could be configured in accordance with the teachings of U.S. Pat. No. 11,453,444.

As shown, a drum brake assembly 106 is mounted to axle flange 105 and a wheel/tire 107 are secured to axle 101 via spindle 102 and hub 103 (not visible). Auxiliary flange 110 is spaced inwardly from axle flange 105.

Vehicle protection system 300 includes a fender 301 and one or more mounting members 302 that may be secured to auxiliary flange 110 (e.g., via bolts 303) to thereby position fender 301 around the top portion of tire 107. Mounting member(s) 302 may be vertically oriented and may, in some embodiments, wrap at least partially around axle 101. However, any suitable configuration could be used to secure mounting member(s) 302 to auxiliary axle 101.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. An axle for a vehicle comprising:
opposing axle flanges that are positioned towards ends of the axle; and
opposing auxiliary flanges that are spaced inwardly from the axle flanges.

2. The axle of claim 1, wherein each of the auxiliary flanges includes one or more holes by which a vehicle protection system is secured to the auxiliary flange.

3. The axle of claim 1, further comprising:
opposing spring leaf mounts that are spaced inwardly from the auxiliary flanges.

4. The axle of claim 1, wherein the auxiliary flanges are welded to the axle.

5. An axle assembly comprising:
an axle having opposing axle flanges that are positioned towards ends of the axle and opposing auxiliary flanges that are spaced inwardly from the axle flanges.

6. The axle assembly of claim 5, further comprising:
a vehicle protection system secured to each auxiliary flange.

7. The axle assembly of claim 6, wherein the vehicle protection system comprises one or more mounting members that are secured to the auxiliary flange and a fender that is supported by the one or more mounting members overtop a tire that is secured to the axle.

8. The axle assembly of claim 6, further comprising:
a brake drum assembly secured to each axle flange.

9. An axle for a vehicle comprising:
opposing axle flanges that are positioned towards ends of the axle, the axle flanges being configured to secure brake drum assemblies to the axle; and
opposing auxiliary flanges that are spaced inwardly from the axle flanges, the auxiliary flanges being configured to secure vehicle protection systems to the axle.

10. The axle of claim 9, wherein each of the auxiliary flanges includes a plurality of holes by which mounting members of the vehicle protection system are secured to the auxiliary flange.
